(19) United States
(12) Patent Application Publication
(10) Pub. No.: US 2021/0388757 A1
(43) Pub. Date: Dec. 16, 2021

(54) AIR ENERGY STORAGE WITH INTERNAL COMBUSTION ENGINES

(71) Applicant: Bechtel Infrastructure and Power Corporation, Reston, VA (US)

(72) Inventor: Seyfettin Can Gülen, Middletown, MD (US)

(73) Assignee: Bechtel Infrastructure and Power Corporation, Reston, VA (US)

(21) Appl. No.: 17/342,618

(22) Filed: Jun. 9, 2021

Related U.S. Application Data
(60) Provisional application No. 63/039,048, filed on Jun. 15, 2020.

(51) Int. Cl. F02B 43/10; F02C 3/34; F02C 3/22; F03D 9/19

(52) U.S. Cl. CPC F02B 43/10; F02C 3/34; F02C 3/22; F03D 9/19; F05B 2220/70642; F05D 2210/12; F05D 2220/7642; F05B 2220/704; F02B 2043/106

(57) ABSTRACT

The present invention relates to a method and system for increasing power output and enhancing efficiency of an internal combustion engine, which comprises: cooling exhaust gas of the engine in a recuperating heat exchanger by transferring heat to stored air; compressing the exhaust gas to a pressure requisite for admission into the engine utilizing a compander module powered by expanding previously compressed and stored air in an expander without parasitic power consumption; mixing the exhaust gas with expanded air; and cooling or heating the exhaust gas to a suitable temperature in a final trim cooler or heater and supplying the exhaust gas to the engine at a pressure requisite at an admission point, without the need for additional compression and concomitant parasitic power consumption needed for exhaust gas recirculation. Extra electric power output and higher thermal efficiency is facilitated by using the excess power generation from the compander in a synchronous AC generator.

### CROSS REFERENCE TO RELATED APPLICATION

This application claims the benefit of U.S. Provisional Patent Application No. 63/039,048 filed Jun. 15, 2020.

### FIELD OF THE INVENTION

The present invention relates to energy storage utilizing air as a storage medium, in order to enable firing high-hydrogen content or 100% hydrogen gaseous fuel in internal combustion engines (ICEs) for electric power generation, with low or zero carbon dioxide emission.

### BACKGROUND OF THE INVENTION

Carbon-free electric power generation utilizing wind and solar resources has dramatically increased their share in the overall power generation portfolio. Advances made in respective technologies have provided opportunities for grid-scale generation at an affordable cost, even without subsidies.

A drawback of either technology is their inability to be available for dispatch when and where needed. The logical solution to this problem is converting the power generated by wind or solar farms at times of low demand into stored energy, which can be readily dispatched when there is demand, but not enough wind or solar power to meet it. One way to accomplish such energy storage is to utilize surplus power generated by wind or solar resources, which otherwise had to be curtailed, i.e., wasted without being put to a good use, to run an electrolyzer to convert water into hydrogen (H₂) and oxygen (O₂). The hydrogen thus produced can be stored on-site or transported to a different location to be later used as fuel in an internal (or external) combustion engine, e.g., a gas turbine or reciprocating (piston-cylinder) engine, for carbon-free electric power generation. Presently, this method of energy storage has not progressed beyond the demonstration or pilot plant stage. In contrast, a proven method of large-scale energy storage utilizes compressed air as the storage medium.

### PRIOR ART

As shown in FIG. 1, power generated by a renewable generation source such as a wind turbine farm (100) is used to run an electrolyzer (200), in which hydrogen and oxygen are produced from water via electrolysis reaction:

2H₂O(l)→2H₂(g)+O₂(g)

According to the reaction formula, 1/9 (0.11) kg of H₂ and 8/9 (0.89) kg O₂ is produced from 1 kg of water via electrolysis. Hydrogen generated by the electrolyzer (200) is compressed in an intercooled compressor (202) to the storage pressure. The storage reservoir (203) can be a naturally extant cavern or a man-made vessel. Stored hydrogen can be utilized on-site, in which case the process (204) can include a heat exchanger and a turboexpander or pressure reduction valve to bring H₂ pressure and temperature to levels requisite for combustion in an ICE power plant (205), which can be a gas turbine or a reciprocating (piston-cylinder) engine. Depending on the particular combustor technology utilized in the ICE, H₂ can be mixed with another gaseous fuel, e.g., methane (CH₄). Furthermore, for NOx emissions control, water or steam (H₂O) can be injected into the combustor. Obviously, for carbon-free and sustainable power generation, the desirable technology option is 100% H₂ combustion without diluent H₂O injection.

Another possibility is transporting stored H₂ via pipelines and/or tankers, and/or other means to a distant site of utilization, which can be power generation or another industrial facility. In that case, the process (204) includes pipelines with compressor stations, local storage reservoirs, and other equipment to set the pressure and temperature of transported and stored H₂ to levels requisite for utilization in an ICE.

One example of proven energy storage technology is compressed air energy storage (CAES), which is depicted schematically in FIG. 2.

In CAES technology, surplus power from a carbon-free generation resource such as solar or wind energy (100) is used to drive a compressor (251) to pressurize ambient air to a pressure suitable for long-term storage in a reservoir (252). When there is power demand, stored compressed air is supplied through a valve (253) and recuperating heat exchanger (254) to a gas turbine (255), which burns a fuel to generate electric power. Hot exhaust gas from the gas turbine is utilized in the recuperator (254) to increase the temperature of compressed and stored air before entry into the gas turbine combustor. Since no parasitic compressor power is involved during this process, net power supplied to the grid is roughly twice the value of the same gas turbine with its compressor and burning the same amount of fuel.

Another emerging energy storage technology with air as a storage medium is liquefied air energy storage (LAES). This technology, also referred to as Cryogenic Energy Storage (CES), uses electricity to cool air until it liquefies, stores the liquid air in a tank, brings the liquid air back to a gaseous state (by exposure to ambient air or with waste heat from an industrial process) and uses that gas to turn a turbine and generate electricity. The generic LAES process is shown in FIG. 3. During charging, air is drawn via ambient air stream (10) from the atmosphere and cleaned of dust and other non-gaseous pollutants in an inlet filter (260). Clean air is first compressed to a high pressure in an intercooled compressor (261). Compressed air is cooled to a cryogenic temperature (i.e., close to minus 200° C.) and transferred from gaseous phase to liquid phase in a liquefier (262). The key components in a typical liquefier (262) are a cryogenic gas expander and chiller. The exact details of the air liquefaction process are not of importance for the present invention and it can be treated as a “black box.” It should be noted that during this process, the volume of air reduces by 700 times, i.e., 700 liters of gaseous air at standard temperature and pressure (STP) reduces to only one liter of liquid air. This is what makes the system space efficient vis-à-vis CAES. Cooling the air down to nearly minus 200° C. is necessary because nitrogen (N₂), roughly two-thirds of air by composition, does not become liquid at higher temperatures.

The liquid air is kept stored in a thermally insulated tank (263) (or a multiplicity of tanks) at low pressure. This particular storage technology is cost-effective and mature because similar equipment is widely used for bulk storage of liquid N₂, O₂ and liquefied natural gas (LNG). Large amounts of energy, of the order of gigawatt-hours, can be stored in commercially available equipment.

During discharge, liquid air is compressed in a cryogenic pump (264) and then heated in a heat exchanger (265). The addition of heat results in air at pressure and temperature suitable for driving a gas expander (266) to drive a synchronous AC generator for electric power generation. This generic (basic) LAES process has low efficiency. The efficiency can be greatly improved by storing the heat extracted during cooling and used during the discharge process for warming the liquid air (not shown in FIG. 3. Similarly, the cooling obtained during warming of the gas can be stored and used to cool the air in a subsequent charging operation (not shown in FIG. 3). These improvements are within the control volume (i.e., the proverbial ‘black box’) of the LAES technology and, thus, are not of importance to the present invention. What is of importance for the present invention is that the exhaust gas of the internal combustion engine can be used in the heat exchanger (265) to further increase the enthalpy of the air entering the gas expander (266) and increase the power output for better efficiency.

Hydrogen is a key enabler of carbon-free power generation (here, carbon is a shorthand for carbon dioxide, CO₂) because the combustion product is water vapor (H₂O). In gas turbines with vintage diffusion combustors, burning 100% H₂ gaseous fuel is a mature and proven technology. Nitrogen oxide (NOx) emissions are controlled via diluent water or steam injection into the combustor to reduce flame zone temperature, which is a key driver of NOx formation. The drawback is increasing water scarcity in many geographic locations, which results in strict environmental regulations, limiting the usage of water in power plants. There is also performance degradation associated with irreversible mixing of steam and fuel, lost steam turbine power (if steam is extracted from the bottoming steam cycle in a gas turbine combined cycle) and reduced turbine inlet temperature (for maintaining parts life, because higher H₂O content of hot gas increases heat transfer from the gas path to the metal components).

In modern gas turbines equipped with lean premix (known as “dry low NOx” or DLN) combustors, unique properties of H₂ such as high flammability, low ignition energy (vis-à-vis methane) and high flame speed present significant design challenges such as flashback, high pressure drop and unstable combustion if H₂ content in the fuel gas exceeds 5% (v). All major original equipment manufacturers (OEM) are actively developing DLN combustors that can ultimately handle 100% H₂ fuel. (Presently, the state-of-the-art is 30% (v) H₂ in the fuel gas).

Similar challenges are present in piston-cylinder engines due to the aforementioned properties of H₂, which requires design modifications such as non-platinum tipped spark plugs in car engines (to avoid spark plug electrode temperatures exceeding the auto-ignition limit and causing backfire; platinum can act as a catalyst to H₂ oxidation), fuel injectors designed for H₂ instead of natural gas in natural gas-fired spark-ignition power-generation units, avoidance of hot spots in the cylinder (to prevent auto-ignition and backfiring) by promoting turbulence and rapid mixing of fuel and air, exhaust gas recirculation (EGR) to minimize NOx production, and others. Other NOx control techniques are equivalence ratios of 0.65 or lower (lean burn) and water injection (same drawback as in the case of gas turbine diffusion combustors, i.e., water scarcity). Major engine OEMs such as Wärtsilä are active in product development to enable higher content of H₂ in engine fuel gas (up to 60% (v)). Without development, current capability of gas-fired spark-ignition engines in terms of maximum allowable H₂ content in fuel gas is about the same as that in gas turbine DLN combustors, i.e., 5% (v).

Similarly, EGR can also be deployed in gas turbines equipped with diffusion or DLN combustors to suppress the flame zone temperature and reduce NOx emissions. As mentioned above, in diffusion combustors, NOx reduction is achieved via diluent injection (e.g., nitrogen, steam, or water). Utilizing EGR in a diffusion combustor would significantly reduce or eliminate diluent injection, resulting in reduced cost and complexity and increased system thermal efficiency.

### SUMMARY OF THE INVENTION

The present invention utilizes CAES or LAES in an innovative way to enable up to 100% (v) H₂ combustion in a RICE or gas turbine, both internal combustion engines, with high efficiency and low NOx emissions. The present invention discloses a unique way to utilize compressed and stored air in an internal combustion engine (ICE) in an efficient manner, in order to enable combustion of up to 100% H₂ fuel in the engine.

### BRIEF DESCRIPTION OF THE DRAWINGS

FIG. 1 is a schematic diagram of energy storage with hydrogen, i.e., prior art with hydrogen stored as compressed gas in a reservoir (very high pressure, moderate temperature).

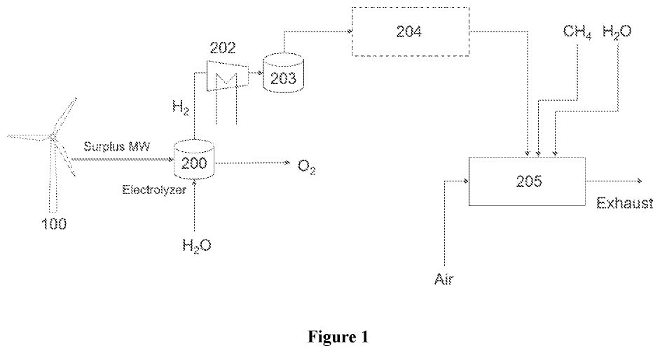

FIG. 2 is a schematic diagram of a generic compressed air energy storage (CAES) process.

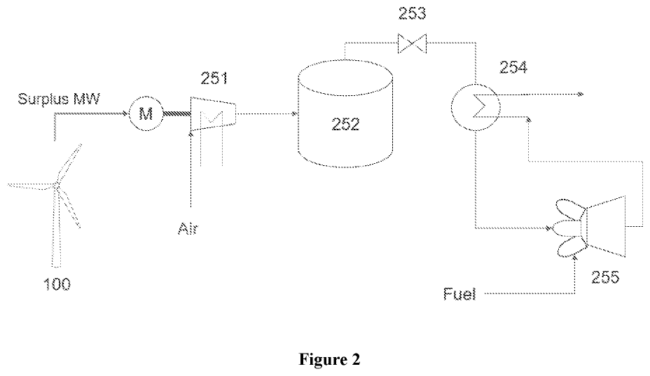

FIG. 3 is a schematic diagram of a generic liquid air energy storage (LAES) process.

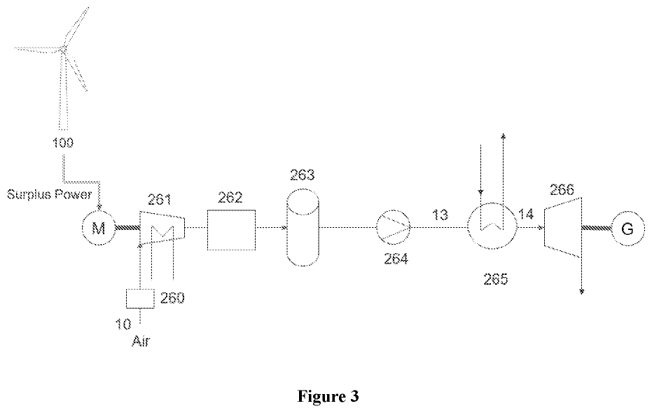

FIG. 4 is a schematic diagram of a preferred embodiment of the present invention, i.e., CAES with Reciprocating ICE (RICE) and Exhaust Gas Recirculation (EGR), providing a detailed, quantitative description of the invention.

FIG. 5 is a diagram of a RICE with a turbocharger module, equipped with a generator for operation within the present invention.

FIG. 6 is a diagram of a RICE with exhaust turbine and generator, for operation within the present invention.

FIG. 7 displays a further embodiment of the present invention, i.e., CAES with gas turbine (GT) and EGR.

FIG. 8 is a diagram representing an alternative admission point (gas turbine compressor discharge—combustor inlet) for a recirculated gas and air mixture.

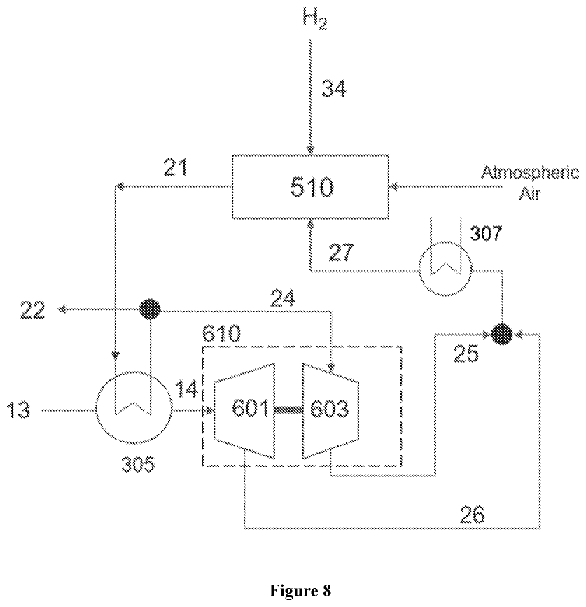

FIG. 9 illustrates a further embodiment of the present invention, i.e., LAES with gas turbine (GT) combined cycle and EGR.

### DETAILED DESCRIPTION OF THE INVENTION

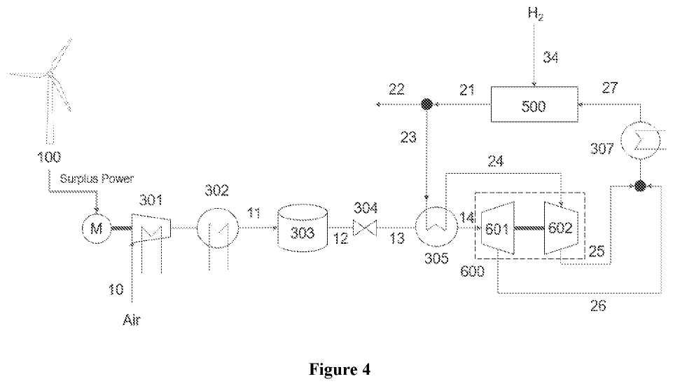

The present invention is described in FIG. 4 using one embodiment, i.e., RICE with EGR and CAES. This particular embodiment is used for the detailed, quantitative description of the present invention. Surplus power from a carbon-free generation resource such as solar or wind energy (100) is utilized to compress an ambient air stream (10) in an intercooled, multi-stage process compressor (301) to the storage pressure (100 bar), which is then cooled in an aftercooler with moisture removal (302) to storage temperature (50° C.). Pressurized and cooled air stream (11) is delivered to the storage reservoir (303). This completes the “charge” phase of the energy storage process.

Note that the surplus power source (100) can be a fossil fuel-fired generation asset as well. One example would be a gas fired combined cycle power plant running overnight (in order not to shut down for fast load ramp up next morning and avoid thermal stresses) and generating power at very low prices (or even a “negative” price, i.e., the storage facility is paid to use the generated surplus power). Another example is a nuclear power plant that must run at full load at all times, whether there is a demand for power or not. This would create an arbitrage opportunity, i.e., the ability to make a profit by discharging stored air and generating power when electricity prices are much higher. The type of the surplus power source is immaterial to the present invention.

During the “discharge” phase of the process, compressed air stream (12) is sent through a pressure control valve (304) to a recuperating heat exchanger (305) and heated to a temperature of 250° C. by cooling the recirculated portion of the RICE (500) exhaust gas stream 24 from the discharge temperature (327° C.) to 70° C. It should be emphasized that the numbers cited herein are meant to be representative of the process based on a particular RICE for illustration purposes and thus subject to change and optimization, particularly by the engine OEM, for actual field deployment. Compressed air stream (14) at 50 bar and 250° C. is expanded through the expander section (601) of a “compander” (combined compressor-expander) (600), which drives the compressor (602) of the same. The compander (600) can be self-balanced (i.e., no net power generation or consumption) as depicted in FIG. 4 or it can be designed to generate excess power to be used in a generator. The particular configuration is subject to optimization during the detailed design phase.

Compressor (602), which is on the same shaft as expander (601), increases the pressure of the recirculated portion of the exhaust gas (24) from 1 bar to 5 bar. Recirculated and pressurized exhaust gas stream (25) mixes with the expanded air stream (26) and is cooled in the trim cooler (307) to a temperature of 50° C. Mixed air-gas stream (27) at 5 bar and 50° C. comprises the charge air for the RICE (500), which is ideally designed to burn 100% H₂ fuel gas (stream 34).

Exhaust gas stream (21) of the RICE (500) at 1 bar and 325° C. is separated into two streams, 22 and 23. Stream 22 is sent to the stack whereas stream 23 is sent to the recuperator (305). Based on the assumption that recirculated gas stream 23 flow rate is 40% of the RICE exhaust flow stream 21, selected stream properties are summarized in Table 1.

TABLE 1
Air and gas stream data

| | 10 | 21 | 23 | 27 | 34 |
|---|---|---|---|---|---|
| | Air | Gas | Gas | Air + Gas | Fuel |
| Flow rate, kg/h | 64,760 | 109,300 | 43,720 | 108,100 | 1,180 |
| Temperature, ° C. | 15.0 | 327.0 | 327.0 | 50.0 | 25.0 |
| Pressure, bar | 1.0 | 1.0 | 1.0 | 1.0 | 20.7 |
| O₂, %(v) | 20.74 | 6.86 | 6.86 | 14.88 | 0.00 |
| H₂O, %(v) | 1.01 | 23.37 | 23.37 | 10.12 | 0.00 |
| H₂, %(v) | | | | | 100 |

The engine selected for the sample calculation has the following performance: 18.9 MWe generator output; 48% net LHV efficiency, and; 1,180 kg/h H₂ consumption (LHV of 120,068 kJ/kg).

The engine is loosely based on MAN 18V51/60 with performance calculated using Thermoflow, Inc.'s THERMOFLEX heat and mass balance simulation software. The base unit is a medium speed (500 rpm), 18-cylinder gas engine available in 18.7 and 20.4 MW electric output versions (MAN 51/60G). Although no detailed information is available on the turbocharger, using typical values of 5 bar charge air pressure and single-stage charge compressor, based on 30 kg/s charge air flow rate, compressor power consumption is estimated as 7.5 MW, which is supplied by the exhaust gas turbine of the turbocharger unit.

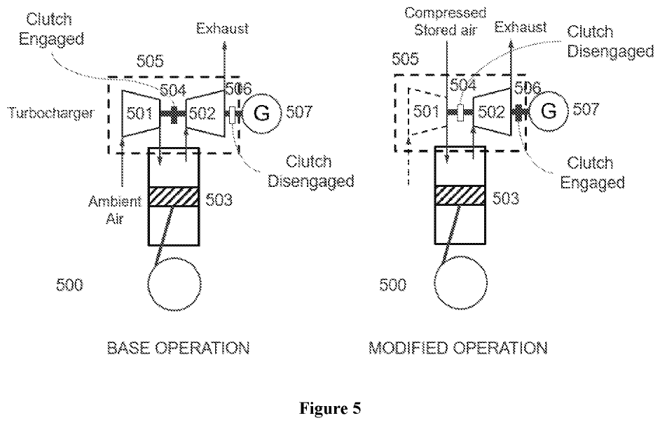

According to the present invention, as illustrated in FIG. 5, if the turbocharger (505) of the RICE (500) is modified (i) to include a clutch/coupling (504) between the compressor (501) and turbine (502) and (ii) a generator (507) attached to the turbine by another clutch/coupling (506), during the discharge phase of the energy storage process, the compressor (501) can be deactivated (clutch 504 disengaged), and 5 bar charge air is directly supplied to the engine (engine cylinder 503). At the same time the generator (507) is activated (clutch 506 engaged) and electric power is supplied to the grid. As a result, with the same amount of fuel consumption, net output increases to 18.9+7.5=26.4 MW and the engine efficiency becomes 26.4/18.9×48%=67%.

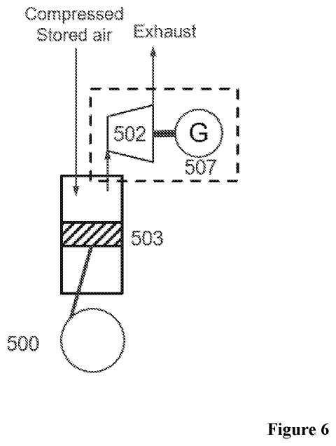

Alternatively, if the RICE is to be deployed exclusively in an energy storage mode, the turbocharger module can be modified by permanently removing the compressor and adding a generator (FIG. 6).

Power consumption of the intercooled compressor (301) during the charge phase of the process is calculated as 11 MW (including the power consumed by the fin-fan coolers for inter- and aftercoolers—not shown in FIG. 4). Engine heat consumption during the discharge phase is:

(1,180/3,600)kg/s×120,068 kJ/kg=39.4 MWth.

Arguably, the most useful measure of CAES performance is the “primary energy efficiency” (PEE), which is the ratio of generated energy to consumed energy, i.e.,

$$PEE = \frac{{t}_{g} \cdot {\dot{W}}_{E}}{{t}_{c} \cdot {\dot{W}}_{C} + {t}_{g} \cdot \overline{η} \cdot \dot{{Q}_{F}}} \qquad 1$$

where:
\dot{W}_{E}=RICE (in this case) net power output during discharge, MWe or kWe
\dot{W}_{C}=Total power consumption during charging, MWe or kWe
\dot{Q}_{F}=Total fuel consumption of the RICE, MWth or kWth
t_{g}=Time of generation, hours
t_{c}=Time of charging, hours
η̅=Average power plant efficiency

This equation provides an electricity-to-electricity roundtrip efficiency that isolates the energy losses in the conversion of electricity to compressed air and back to electricity. The second term in the denominator of the PEE formula represents the electric energy that could have been generated with the same amount of fuel input with average power plant efficiency (45.5% for natural gas-fired, 32.7% coal-fired power plants in the U.S. in 2015 based on U.S. Energy Information Administration data). Assuming t_{g}=t_{c} and η̅=50%, the PEE of the present invention becomes:

$$PEE = \frac{26.4}{11 + 50 \% \cdot 39.4} = 86 \% .$$

Thus, the present invention increases the base engine output by 7.5/18.9=40% in energy storage mode at the same fuel consumption as in base operation mode; improves the heat rate (efficiency) by the same factor; and enables (or, at the very least, contributes significantly to enabling) 100% H₂ combustion for carbon-free power generation.

It should be noted that the present invention can also be applied to operation with natural gas or a mixture of H₂ and methane (CH₄), or a syngas (mainly, a mixture of H₂ and CO). Exhaust gas recirculation is beneficial to reduction of NOx emissions with any gaseous fuel by the same mechanism, i.e., reduction of flame temperature by dilution with an inert gas component (e.g., H₂O and/or CO₂). However, unlike the case with combustion of 100% H₂, exhaust gas will include CO₂.

### Description of the Preferred Embodiments

There are multiple embodiments of the present invention, including: CAES with RICE (simple or combined cycle) and EGR; CAES with gas turbine (simple or combined cycle) and EGR; LAES with RICE (simple or combined cycle) and EGR; and LAES with gas turbine (simple or combined cycle) and EGR.

The invention is described quantitatively using a preferred embodiment, i.e., CAES with RICE (simple cycle) and EGR (FIG. 4). It should be noted that simple cycle means that the exhaust gas of the internal combustion engine (RICE or gas turbine) is not used in a “bottoming cycle” for additional power generation. The bottoming cycle can be a steam Rankine cycle or an “organic” Rankine cycle (ORC), or any type of heat engine cycle where the heat content of the internal combustion engine exhaust gas can be utilized as cycle heat input.

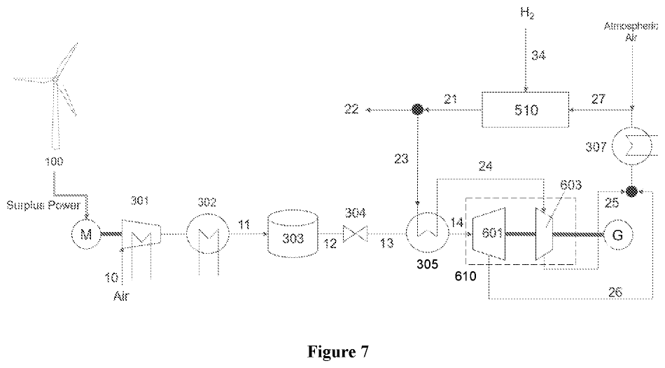

A further embodiment of the present invention, CAES with gas turbine and EGR, is shown in FIG. 7. The charge process is the same. During the discharge phase of the process, compressed air stream (12) is sent through a pressure control valve (304); the cold stored air (13) is then sent to a recuperating heat exchanger (305) and heated to a suitably high temperature by cooling the recirculated portion of the gas turbine (510) exhaust gas stream (23). It should be noted that the actual numbers are subject to determination and optimization, particularly by the gas turbine OEM, for actual field deployment. Compressed air stream (14) is expanded through the expander section (601) of the compander (610), which drives the booster fan (603) of the same. The compander (610) is designed to generate excess power to be used in a generator. Recirculated and pressurized exhaust gas stream (25) mixes with the expanded air stream (26) and cooled in the trim cooler (307) to a temperature suitable for mixing with atmospheric air to form stream (27) and admission into the compressor inlet of the gas turbine (510).

Another possible admission point for the mixed stream is at the compressor discharge of the gas turbine (510). In that case, stream (27) mixes with the compressed air from the gas turbine compressor discharge and enters the combustor. In order to minimize the temperature discrepancy, recirculated gas and air mixture is heated in the heat exchanger (305) utilizing GT exhaust gas (a portion of it) or working fluid (e.g., steam or water) from the bottoming cycle (700, in the case of a combined cycle configuration). In this case, however, the compander (610) includes the component (603), which is a compressor (i.e., higher pressure ratio and power consumption) instead of a booster “fan.” This is the case because the pressure at the admission point is higher (e.g., 20 bara or more for modern advanced class heavy duty industrial gas turbines) than atmospheric (i.e., 1 bara). In that instance, the likelihood of excess power generation from the compander is unlikely (but not impossible). The particular configuration and performance is subject to optimization during the detailed design phase.

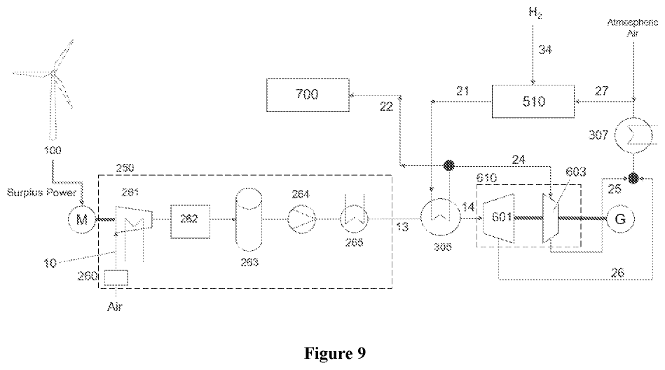

In a further embodiment of the present invention, LAES with gas turbine (in combined cycle) and EGR is shown in FIG. 9. In the charge process, air (10) is drawn from the atmosphere and cleaned of dust and other non-gaseous pollutants in an inlet filter (260). Clean air is first compressed to a high pressure in an intercooled compressor (261). Compressed air is cooled to a cryogenic temperature and liquefied in a liquefier (262). This liquid air is kept stored in thermally insulated tanks (263) at low pressure. During discharge, liquid air is compressed in a cryogenic pump (264) and then heated in one or more heat exchangers (265) utilizing stored heat within the LAES facility (250) or merely ambient air.

Cryogenically stored air stream (13) from the LAES (250) is heated in the heat exchanger (305) utilizing the exhaust gas (21) from the gas turbine (510). Heated air stream (14) is expanded through the expander section (601) of the compander (610), which drives the booster fan (603) of the same. The compander (610) is designed to generate excess power to be used in a generator. After heating the stored air, gas turbine exhaust gas stream is divided into two branches. Stream (24) goes through the compander (610) and constitutes the circulated portion of the exhaust gas stream (21). Stream (22) goes into the bottoming cycle (700), where it heats the working fluid (steam, hydrocarbon, or another fluid) for additional power generation. The particular configuration is subject to optimization during the detailed design phase.

From the three embodiments shown in FIGS. 4, 7 and 9, it would be apparent to one of ordinary skill in the art how the remaining five embodiments can be constructed by mixing and matching the CAES, LAES, RICE, and GT components.

What is claimed is:

1. A method for increasing power output and enhancing efficiency of an internal combustion engine, which comprises:
(a) cooling exhaust gas of the engine in a recuperating heat exchanger by transferring heat to stored air;
(b) compressing the exhaust gas to a pressure needed for admission into the engine utilizing a compander module powered by expanding previously compressed and stored air in an expander without parasitic power consumption;
c) mixing the exhaust gas with expanded air; and
d) cooling or heating the exhaust gas to a suitable temperature in a final trim cooler or heater and supplying the exhaust gas to the engine at a pressure requisite at an admission point, without the need for additional compression and concomitant parasitic power consumption needed for exhaust gas recirculation.

2. The method as recited in claim 1, wherein surplus power from a carbon-free generation resource is used to compress an ambient air stream in an intercooled, multi-stage process compressor to storage pressure, which is then cooled in an aftercooler with moisture removal to storage temperature.

3. The method as recited in claim 2, wherein the carbon-free generation resource is solar or wind energy.

4. The method as recited in claim 2, wherein the storage pressure is 100 bar.

5. The method as recited in claim 2, wherein the storage temperature is 50° C.

6. The method as recited in claim 2, wherein a surplus power source is a fossil fuel-fired generation asset.

7. The method as recited in claim 6, wherein the fossil fuel-fired generation asset is a gas fired combined cycle power plant running overnight, or a nuclear power plant running at full load.

8. The method as recited in claim 2, wherein up to 100% (v) H₂ combustion is enabled for carbon-free power generation.

9. The method as recited in claim 1, wherein the compander is self-balanced or designed to generate excess power to be used in a generator.

10. The method as recited in claim 1, wherein the gas is natural gas or a mixture of H₂ and methane (CH₄), or a syngas.

11. The method as recited in claim 1, wherein the internal combustion engine is a reciprocating internal combustion engine.

12. The method as recited in claim 1, wherein the internal combustion engine is a gas turbine.

13. The method as recited in claim 1, wherein compressed air energy storage enables up to 100% (v) H₂ combustion in the internal combustion engine, with enhanced efficiency and reduced NOx emissions.

14. The method as recited in claim 1, wherein liquefied air energy storage enables up to 100% (v) H₂ combustion in the internal combustion engine, with enhanced efficiency and reduced NOx emissions.

15. The method as recited in claim 1, wherein extra electric power output and higher efficiency is facilitated by using excess power generation from the compander in a synchronous AC generator.

16. A system for increasing power output and enhancing efficiency of an internal combustion engine, which comprises:
(a) cooling exhaust gas of the engine in a recuperating heat exchanger by transferring heat to stored air;
(b) compressing the exhaust gas to a pressure needed for admission into the engine utilizing a compander module powered by expanding previously compressed and stored air in an expander without parasitic power consumption;
c) mixing the exhaust gas with expanded air; and
d) cooling or heating the exhaust gas to a suitable temperature in a final trim cooler or heater and supplying the exhaust gas to the engine at a pressure requisite at an admission point, without the need for additional compression and concomitant parasitic power consumption needed for exhaust gas recirculation.
